(19) United States
(12) Patent Application Publication
(10) Pub. No.: US 2025/0054656 A1
(43) Pub. Date: Feb. 13, 2025

(54) ELECTRIC WIRE WITH TERMINAL AND METHOD OF MANUFACTURING THE SAME

(71) Applicant: YAZAKI CORPORATION, Tokyo (JP)

(72) Inventors: Fuminori KONDO, Shizuoka (JP); Yusaku OHKI, Shizuoka (JP); Hiroyuki TANAKA, Shizuoka (JP)

(73) Assignee: YAZAKI CORPORATION, Tokyo (JP)

(21) Appl. No.: 18/932,754

(22) Filed: Oct. 31, 2024

Related U.S. Application Data
(63) Continuation of application No. PCT/JP2023/037510, filed on Oct. 17, 2023.

(30) Foreign Application Priority Data
Oct. 17, 2022 (JP) 2022-166071

(51) Int. Cl. H01B 7/282

(52) U.S. Cl. CPC H01B 7/282

(57) ABSTRACT

An electric wire with a terminal includes an electric wire in which a single wire is disposed at an end of a conductor, and the single wire is continuously and integrally connected to a plurality of element wires; a covering material that spans a portion of the single wire and a portion of an insulation sheath to cover an entire surface of a bundle of a plurality of element wires of a conductor exposed portion; and a terminal that includes a conductor connector connected to the single wire.

### CROSS-REFERENCE TO RELATED APPLICATIONS

The present application is a continuation of International Application No. PCT/JP2023/037510, filed on Oct. 17, 2023, and based upon and claims the benefit of priority from Japanese Patent Application No. 2022-166071, filed on Oct. 17, 2022, the entire contents of which are incorporated herein by reference.

### TECHNICAL FIELD

The present disclosure relates to an electric wire with a terminal and a method of manufacturing an electric wire with a terminal.

### BACKGROUND

There is a prior known electric wire with a terminal that has an electric wire with a conductor having a plurality of element wires and a terminal connected to the conductor. If this kind of electric wire with the terminal is used in a place such as an engine room of an automobile where water may enter, water may enter between the element wires, and the conductor may be corroded. Therefore, an electric wire with a terminal has been known in which a plurality of element wires are covered with a heat-shrinkable tube to prevent water from entering between the element wires of a conductor.

JP 2000-285983 A discloses a waterproof structure of a ground terminal for an automobile. In this structure, a core wire is press-fastened and crimped with a core wire crimping barrel, and an insulation sheath of an electric wire is press-fastened and crimped with an insulation sheath crimping barrel. One end side of a heat-shrinkable tube completely covers the core wire press-fastened and crimped with the core wire crimping barrel, and the other end side is in close contact with the electric wire. An adhesive is applied to an inner peripheral surface of the heat-shrinkable tube, and the adhesive adheres to the ground terminal and electric wire to eliminate a gap.

### SUMMARY OF THE INVENTION

According to JP 2000-285983 A, the adhesive applied to the inner peripheral surface of the heat-shrinkable tube fills a gap between core wires to prevent water from entering between a plurality of element wires. However, there is a risk that the adhesive may not sufficiently penetrate to a center portion of a conductor due to variations in each element wire diameter and each conductor diameter. In particular, when the electric wire is used in a bent state while a gap remains between conductors, the gap between the core wires becomes large, and there is a risk that water may easily enter an end of the electric wire.

The present disclosure has been devised in view of the problems of the previously existing technology. An object of the present disclosure is to provide an electric wire with a terminal and a method of manufacturing an electric wire with a terminal, capable of preventing water from entering between element wires of a conductor.

An electric wire with a terminal according to an aspect of the present disclosure includes: an electric wire that includes a conductor including a plurality of element wires and an insulation sheath covering an outer periphery of the conductor, and that includes therein a conductor exposed portion in which the conductor is exposed from the insulation sheath, and a conductor covered portion in which the conductor is covered with the insulation sheath, the conductor exposed portion including a single wire, the single wire being disposed at an end of the conductor, and the single wire being continuously and integrally connected to the plurality of element wires; a covering material that spans a portion of the single wire and a portion of the insulation sheath to cover an entire surface of a bundle of the plurality of element wires of the conductor exposed portion; and a terminal that includes a conductor connector connected to the single wire and a terminal connector configured to be connected to a mating terminal.

A method of manufacturing an electric wire with a terminal according to another aspect of the present disclosure includes: a step of covering an entire surface of a bundle of a plurality of element wires of a conductor exposed portion with a covering material by the covering material spanning a portion of a single wire and a portion of an insulation sheath, in an electric wire that includes a conductor including the plurality of element wires and the insulation sheath covering an outer periphery of the conductor, and that includes therein the conductor exposed portion in which the conductor is exposed from the insulation sheath, and a conductor covered portion in which the conductor is covered with the insulation sheath, the conductor exposed portion including the single wire, the single wire being disposed at an end of the conductor, and the single wire being continuously and integrally connected to the plurality of element wires; and a step of connecting the single wire to a terminal including a terminal connector configured to be connected to a mating terminal.

According to the present disclosure, it is possible to provide an electric wire with a terminal and a method of manufacturing an electric wire with a terminal, capable of preventing water from entering between element wires of a conductor.

### BRIEF DESCRIPTION OF DRAWINGS

FIG. 1 is a side view schematically illustrating an example of an electric wire with a terminal according to the present embodiment.

FIG. 2 is a cross sectional view schematically illustrating an example of the electric wire with the terminal according to the present embodiment.

FIG. 3 is a cross sectional view schematically illustrating an example of an electric wire with a terminal with a housing.

FIG. 4 is a schematic side view illustrating an example of a state in which an insulation sheath of an electric wire is peeled off.

FIG. 5 is a side view schematically illustrating an example of a single wire which is formed in a conductor exposed portion of an electric wire.

FIG. 6 is a side view schematically illustrating an example of a state in which an electric wire is covered with a covering material.

FIG. 7 is a front view illustrating an example in which a single wire is formed from a plurality of element wires using an ultrasonic welder.

FIG. 8 is a perspective view schematically illustrating an example of a state before assembling a terminal according to the present embodiment.

FIG. 9 is a perspective view schematically illustrating an example of a state after assembling a terminal according to the present embodiment.

### DETAILED DESCRIPTION OF THE INVENTION

An electric wire with a terminal, an electric wire with a connector, and a method of manufacturing an electric wire with a terminal according to the present embodiment will be described in detail below with reference to the drawings. Note that dimensional ratios in the drawings are exaggerated for convenience of the description, and may be different from actual ratios.

[Electric Wire with Terminal]

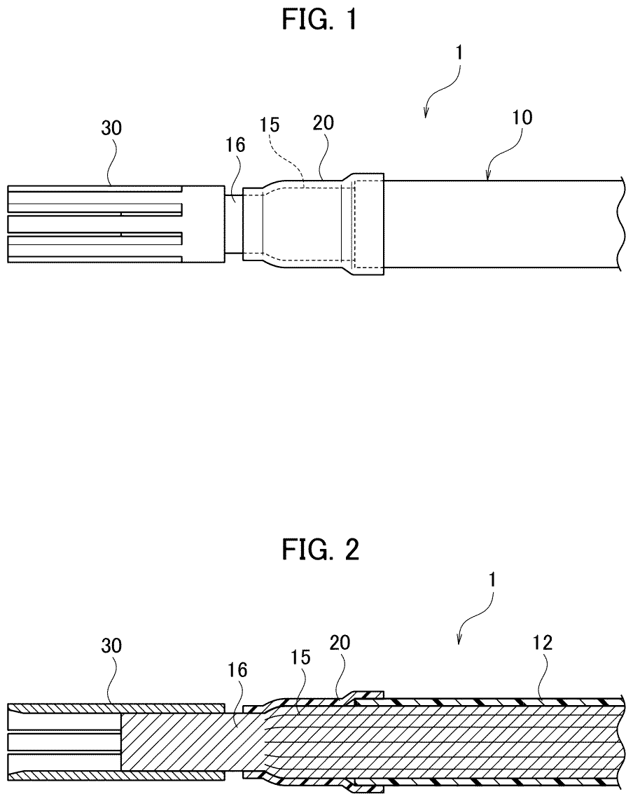

First, an electric wire 1 with a terminal according to the present embodiment will be described. FIG. 1 is a side view schematically illustrating an example of the electric wire 1 with the terminal according to the present embodiment. FIG. 2 is a cross sectional view schematically illustrating an example of the electric wire 1 with the terminal according to the present embodiment. As illustrated in FIGS. 1 and 2, the electric wire 1 with the terminal according to the present embodiment includes an electric wire 10, a covering material 20, and a terminal 30.

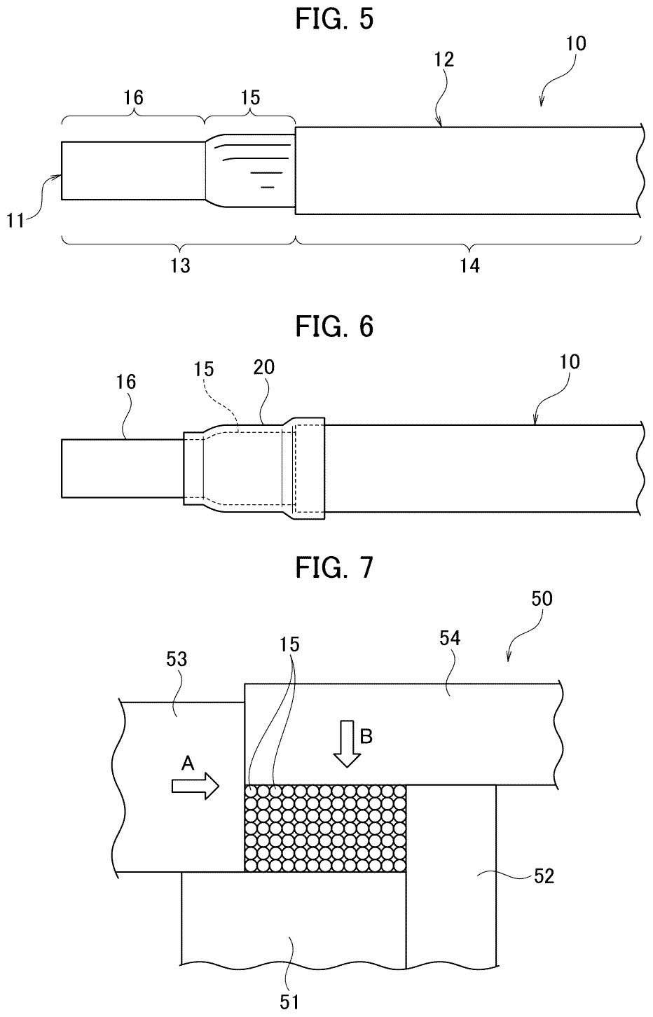

FIG. 5 is a side view schematically illustrating an example of the electric wire 10. As illustrated in FIG. 5, the electric wire 10 includes a conductor 11 and an insulation sheath 12 covering an outer periphery of the conductor 11.

The conductor 11 includes a plurality of element wires 15 and a single wire 16. The plurality of element wires 15 may be an aggregated twisted wire formed by bundling the plurality of element wires 15. Further, the conductor 11 may be constituted by only one aggregated twisted wire, may be a composite twisted wire formed by bundling a plurality of aggregated twisted wires, or may be a round bar conductor in the electric wire 10. As will be described later, the single wire 16 is a single conductor formed of the plurality of element wires 15 by means of welding, for example.

As a material of the conductor 11, highly conductive metal can be used. A material of the conductor 11 may be copper, aluminum, or an alloy thereof, for example.

As a material of the insulation sheath 12, it is possible to use a thermoplastic resin that can ensure electrical insulation. A material of the insulation sheath 12 may contain at least one of an olefin-based resin and polyvinyl chloride, for example. The olefin-based resin may contain at least one or more resins selected from the group consisting of polyethylene (PE), polypropylene (PP), an ethylene copolymer, and a propylene copolymer, for example.

The electric wire 10 has a conductor exposed portion 13 in which the insulation sheath 12 is peeled off and the conductor 11 is exposed from the insulation sheath 12. Further, the electric wire 10 has a conductor covered portion 14 in which the conductor 11 is covered with the insulation sheath 12. The conductor exposed portion 13 is disposed at an end of the conductor 11.

The conductor exposed portion 13 includes the plurality of element wires 15 and the single wire 16. However, the conductor exposed portion 13 may not include the plurality of element wires 15, and an entirety of the conductor exposed portions 13 may be the single wire 16. The conductor covered portion 14 includes the plurality of element wires 15, but does not include the single wire 16.

The single wire 16 is disposed at an end of the conductor 11. Due to the single wire 16 being disposed at the end of the conductor 11, it is possible to prevent water from entering the conductor 11 from the end of the conductor 11.

The single wire 16 is continuously and integrally connected to the plurality of element wires 15. Specifically, the single wire 16 is continuously and integrally connected to each of the plurality of element wires 15. Further, the diameter of the single wire 16 is larger than the diameter of each element wire 15. There are gaps through which liquids enter between each element wire 15. Meanwhile, the number of paths for liquids to enter the conductor 11 in an axial direction for the single wire 16 is smaller than the number of paths for the plurality of element wires 15. Although the single wire 16 may not have a gap through which a liquid enters, the single wire 16 may include a small number of air gaps, as long as the air gaps are connected to each other not to communicate with a space outside the single wire 16.

The covering material 20 spans a portion of the single wire 16 and a portion of the insulation sheath 12 to cover an entire surface of the bundle of the plurality of element wires 15 of the conductor exposed portion 13. Due to the covering material 20 covering an entire circumferential direction of the plurality of element wires 15, it is possible to prevent a liquid from entering from an outer surface of the plurality of element wires 15. Specifically, the covering material 20 may be a tube. One end of the covering material 20 is connected to an entire circumferential surface of an edge of the single wire 16, and the other end of the covering material 20 is connected to an entire circumferential surface of the insulation sheath 12.

An adhesive may be disposed on an inner peripheral surface of the covering material 20. The type of the adhesive is not particularly limited, and the adhesive may be a hot melt adhesive, for example. By allowing the adhesive to permeate between the element wires 15, liquids can be further prevented from entering between the element wires 15. For the adhesive, a material to which the conductor 11 and insulation sheath 12 adhere can be used. In place of a tube, the covering material 20 may be a substance such as a tape, a substance such as a sheet, or a substance obtained by stacking and hardening thermosetting resins or thermoplastic resins, for example.

The covering material 20 may contain a resin, because a resin has high electrical insulation and is easy to handle. Since a resin can be easily molded by heat, the covering material 20 may contain a thermoplastic resin. The thermoplastic resin may contain at least one selected from the group consisting of polyethylene, polypropylene, polystyrene, polyethylene terephthalate, a vinyl chloride resin, an ABS resin, polycarbonate, an acrylic resin, polybutylene terephthalate, polyacetal, polyamide, aromatic polyamide, polyphenylene sulfide, a liquid crystal polymer, polyvinylidene chloride, and polyvinylidene fluoride, for example.

The terminal 30 includes a conductor connector 31 and a terminal connector 32. The conductor connector 31 is disposed at one end of the terminal 30, and the terminal connector 32 is disposed at the other end of the terminal 30.

The conductor connector 31 is connected to the single wire 16. The conductor connector 31 is configured to be mechanically and electrically connected to the conductor 11 by being connected to the conductor exposed portion 13 of the electric wire 10. The conductor connector 31 covers the conductor exposed portion 13 so as to surround a circumferential direction of the single wire 16. The single wire 16 and conductor connector 31 may be connected by means of welding, such as ultrasonic welding and thermal welding, or may be connected by means of crimping. However, if the single wire 16 and conductor connector 31 are connected by means of crimping such as press-fastening, a contact portion between the conductor connector 31 and single wire 16 may open in a trumpet-like shape. Therefore, it is desirable that the single wire 16 and conductor connector 31 are connected by means of welding.

The terminal connector 32 is configured to be connected to a mating terminal (not illustrated). Due to the terminal connector 32 being connected to a terminal connector of the mating terminal, the terminal 30 is mechanically and electrically connected to the mating terminal. When connected to the conductor 11, the terminal connector 32 has a cylindrical space therein, and the mating terminal (not illustrated) can be inserted into the cylindrical space.

Although an example of the terminal 30 has been described, in the present embodiment, the conductor 11 has the single wire 16, and the bundle of the plurality of element wires 15 is covered with the covering material 20 to prevent a liquid from entering. Therefore, the specific shape of the terminal 30 is not particularly limited, and a terminal of any shape can be used.

The terminal 30 is formed of a conductive material. A material forming the terminal 30 may include at least one metal selected from the group consisting of copper, aluminum, iron, and magnesium, for example. A surface of the terminal 30 may or may not be plated.

As described above, the electric wire 1 with the terminal according to the present embodiment includes the electric wire 10, the covering material 20, and the terminal 30. The electric wire 10 includes the conductor 11 having the plurality of element wires 15, and the insulation sheath 12 covering the outer periphery of the conductor 11. The electric wire 10 has therein the conductor exposed portion 13 in which the conductor 11 is exposed from the insulation sheath 12, and the conductor covered portion 14 in which the conductor 11 is covered with the insulation sheath 12. The conductor exposed portion 13 includes the single wire 16, the single wire 16 is disposed at an end of the conductor 11, and the single wire 16 is continuously and integrally connected to the plurality of element wires 15. The covering material 20 spans a portion of the single wire 16 and a portion of the insulation sheath 12 to cover an entire surface of the bundle of the plurality of element wires 15 of the conductor exposed portion 13. The terminal 30 includes the conductor connector 31 connected to the single wire 16, and the terminal connector 32 configured to be connected to a mating terminal.

In the electric wire 1 with the terminal according to the present embodiment, the single wire 16 is disposed at the end of the conductor 11. The covering material 20 spans a portion of the single wire 16 and a portion of the insulation sheath 12 to cover the entire surface of the bundle of the plurality of element wires 15 of the conductor exposed portion 13. With this configuration, a liquid is blocked by the covering material 20 and the liquid can be prevented from contacting with the plurality of element wires 15.

Therefore, according to the electric wire 1 with the terminal, it is possible to prevent water from entering between the element wires 15 of the conductor.

Further, in accordance with the electric wire 1 with the terminal according to the present embodiment, it is not necessary to provide a mechanism for sealing the plurality of element wires 15 using a rubber component or the like. Therefore, it is possible to contribute to the reduction of a lead time and reduction in size and weight of a product.

[Electric Wire with Connector]

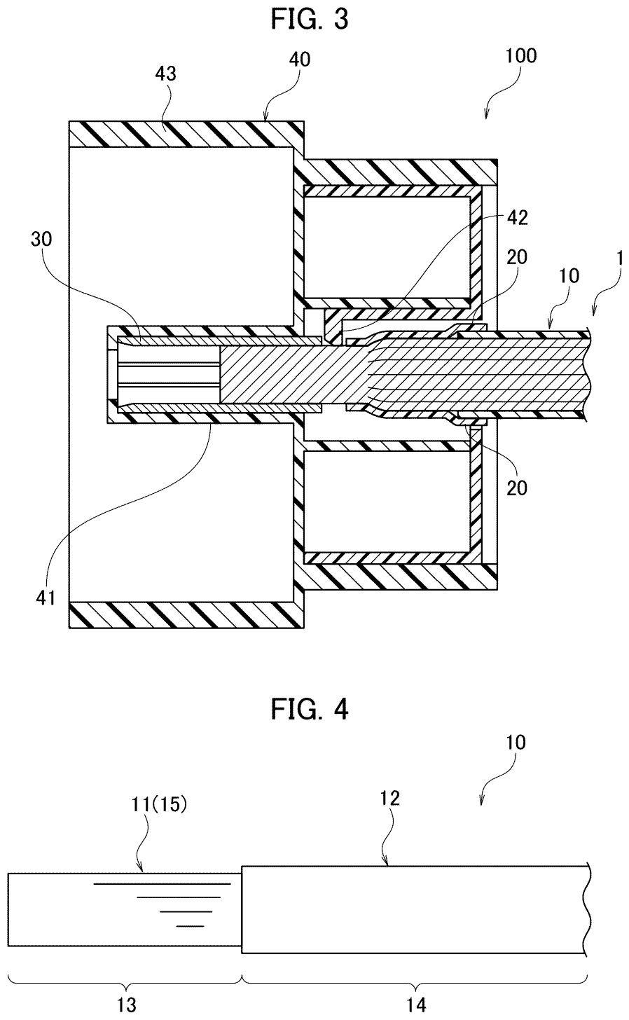

Next, an electric wire 100 with a connector according to the present embodiment will be described. As illustrated in FIG. 3, the electric wire 100 with the connector according to the present embodiment includes the electric wire 1 with the terminal, and a housing 40 for housing the electric wire 1 with the terminal. Due to the housing 40 housing the electric wire 1 with the terminal, the electric wire 10 and terminal 30 can be protected, and the electric wire 1 with the terminal can be easily handled. The housing 40 may include a terminal holder 41, an electric wire holder 42, and a gripper 43. The terminal holder 41 surrounds the entire circumferential direction of the terminal 30 and holds the terminal 30. The electric wire holder 42 holds the electric wire 10 such that the electric wire 10 does not move relative to the terminal 30. The gripper 43 is disposed radially outward from the terminal holder 41 and electric wire holder 42. Due to the gripper 43 being disposed radially outward, the electric wire 1 with the terminal can be easily gripped and handled.

The housing 40 may contain a resin, because a resin has high electrical insulation and is easy to handle. Since a resin can be easily molded by heat, the housing may contain a thermoplastic resin. The thermoplastic resin contains at least one selected from the group consisting of polyethylene, polypropylene, polystyrene, polyethylene terephthalate, a vinyl chloride resin, an ABS resin, polycarbonate, an acrylic resin, polybutylene terephthalate, polyacetal, polyamide, aromatic polyamide, polyphenylene sulfide, a liquid crystal polymer, polyvinylidene chloride, and polyvinylidene fluoride, for example.

[Method of Manufacturing Electric Wire with Terminal]

Next, a method of manufacturing the electric wire 1 with the terminal according to the present embodiment will be described. The method of manufacturing the electric wire 1 with the terminal according to the present embodiment includes a conductor exposing step, a single wire forming step, a covering step, and a connecting step.

FIG. 4 is a schematic side view illustrating an example of a state in which the insulation sheath 12 of the electric wire 10 is peeled off by performing the conductor exposing step. FIG. 5 is a side view schematically illustrating an example of the single wire 16 which is formed in the conductor exposed portion 13 of the electric wire 10 and which is formed by performing the single wire forming step. FIG. 6 is a side view schematically illustrating an example of a state in which the electric wire 10 is covered with the covering material 20 by performing the covering step. FIG. 1 is a side view schematically illustrating an example of the electric wire 1 with the terminal according to the present embodiment formed by performing the connecting step. Each step will be described in detail below.

### (Conductor Exposing Step)

In the conductor exposing step, first, the electric wire 10 is prepared. The electric wire 10 includes the conductor 11 including the plurality of element wires 15, and the insulation sheath 12 covering the outer periphery of the conductor 11. Next, a portion of the insulation sheath 12 of the electric wire 10 is peeled off. As a result, as illustrated in FIG. 4, the electric wire 10 has therein the conductor exposed portion 13 in which the conductor 11 is exposed from the insulation sheath 12, and the conductor covered portion 14 in which the conductor 11 is covered with the insulation sheath 12.

### (Single Wire Forming Step)

In the single wire forming step, the single wire 16 is formed from the plurality of element wires 15 at an end of the conductor exposed portion 13. As a result, as illustrated in FIG. 5, the electric wire 10 is formed, in which the conductor exposed portion 13 has the single wire 16, the single wire 16 is disposed at the end of the conductor 11, and the single wire 16 is continuously and integrally connected to the plurality of element wires 15. Although the single wire 16 is formed from the plurality of element wires 15 in the present embodiment, an electric wire having a single wire therein may be manufactured by joining a twisted wire including a plurality of element wires with a single wire.

There are no particular limitations on a method of forming the single wire 16, and the single wire 16 may be formed from the plurality of element wires 15 by means of ultrasonic welding, thermal welding, or pressing. By melting or atomic diffusion of a surface of each element wire 15 by means of ultrasonic welding, thermal welding, or pressing, the single wire 16 is formed by integrating the plurality of element wires 15. From thereamong, if ultrasonic welding is adopted, it is possible to easily form the single wire 16 from the plurality of element wires 15 in a short time. Therefore, it is preferable that the single wire 16 is formed by welding the plurality of element wires 15 by means of ultrasonic welding.

The ultrasonic welding can be performed using a known ultrasonic welder. The ultrasonic welder may include a horn and an anvil, for example. The horn transmits vibration energy to the plurality of element wires 15. The anvil is a receiver of the horn, and is arranged to face the horn. By transmitting vibration energy to the plurality of element wires 15 via the horn, while sandwiching the plurality of element wires 15 between the horn and the anvil and applying pressure thereto, frictional heat is generated at a contact surface between each element wire 15, and each element wire 15 can be welded due to the frictional heat.

A specific example of an ultrasonic welder will be described with reference to FIG. 7. As illustrated in FIG. 7, an ultrasonic welder 50 according to the present embodiment includes a horn 51, a fixed side plate 52, a movable slide core 53, and an anvil 54. The horn 51 is configured to be ultrasonically vibrated by an ultrasonic oscillator.

The anvil 54 is arranged above the horn 51 and side plate 52, and by the anvil 54 moving up or down, the anvil 54 is configured to be movable in a direction toward or away from the horn 51. In FIG. 7, the anvil 54 moves in a direction illustrated by an arrow B in FIG. 7, and presses the plurality of element wires 15 in the direction.

The side plate 52 faces the slide core 53, and is arranged on a side of the horn 51 in a direction perpendicular to a facing direction of the horn 51 and anvil 54. The slide core 53 is arranged at a position which is on an upper surface of the horn 51 and faces the side plate 52, and is configured to be movable in a direction toward or away from the side plate 52. In FIG. 7, the slide core 53 moves in a direction illustrated by an arrow A in FIG. 7, and presses the plurality of element wires 15 in the direction. The ultrasonic welder 50 can perform ultrasonic welding by vibrating, via the horn 51, the plurality of element wires 15 arranged in a rectangular space in a cross-sectional view defined by the horn 51, side plate 52, slide core 53, and anvil 54.

The single wire 16 having a desired shape can be formed by adjusting the shape of a space in which the plurality of element wires 15 are sandwiched by the horn and the anvil of the ultrasonic welder. Therefore, not only a single wire 16 having a rectangular cross section as illustrated in FIG. 7, but also a single wire 16 having a circular cross section can be formed.

### (Covering Step)

In the covering step, the electric wire 10 is covered with the covering material 20. Specifically, the covering material 20 spans a portion of the single wire 16 and a portion of the insulation sheath 12 to cover the entire surface of the bundle of the plurality of element wires 15 of the conductor exposed portion 13, with the covering material 20. The covering material 20 may be a heat-shrinkable tube. An adhesive may be applied on an inner peripheral surface of the heat-shrinkable tube as described above. By covering a portion of the single wire 16 and a portion of the insulation sheath 12 with the heat-shrinkable tube, and applying heat thereto, the heat-shrinkable tube is shrunk, and it is possible to cover the entire surface of the bundle of the plurality of element wires 15 with the heat-shrinkable tube.

### (Connecting Step)

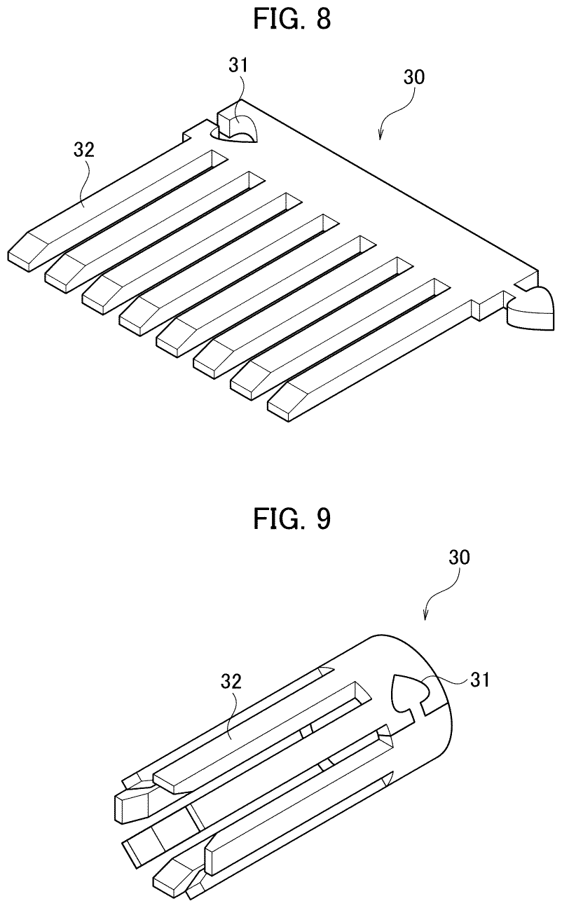

In the connecting step, the single wire 16 is connected to the terminal 30 including the terminal connector 32 configured to be connected to a mating terminal. FIG. 8 is a perspective view schematically illustrating an example of a state before assembling the terminal 30 according to the present embodiment. FIG. 9 is a perspective view schematically illustrating an example of a state after assembling the terminal 30 according to the present embodiment.

By rounding flat plate members as illustrated in FIG. 8 into a cylindrical shape as illustrated in FIG. 9, and connecting the members to the single wire 16, the conductor connector 31 connected to the single wire 16 is formed at one end of the terminal 30. Further, by rounding flat plate members into a cylindrical shape and connecting the members to the single wire 16, the terminal connector 32 configured to be connected to a mating terminal is formed at the other end of the terminal 30. This forms the terminal 30 including the conductor connector 31 and terminal connector 32. The single wire 16 and conductor connector 31 may be connected by means of welding, such as ultrasonic welding and thermal welding, or may be connected by means of crimping. However, if the single wire 16 and conductor connector 31 are connected by means of crimping such as press-fastening, a contact portion between the conductor connector 31 and single wire 16 may open in a trumpet-like shape. Therefore, it is desirable that the single wire 16 and conductor connector 31 are connected by means of welding.

As described above, the method of manufacturing the electric wire 1 with the terminal according to the present embodiment includes the covering step and connecting step. The electric wire 10 includes the conductor 11 having the plurality of element wires 15, and the insulation sheath 12 covering the outer periphery of the conductor 11. The electric wire 10 has therein the conductor exposed portion 13 in which the conductor 11 is exposed from the insulation sheath 12, and the conductor covered portion 14 in which the conductor 11 is covered with the insulation sheath 12. The conductor exposed portion 13 includes the single wire 16, the single wire 16 is disposed at an end of the conductor 11, and the single wire 16 is continuously and integrally connected to the plurality of element wires 15. In the covering step, the covering material 20 spans a portion of the single wire 16 and a portion of the insulation sheath 12 to cover the entire surface of the bundle of the plurality of element wires 15 of the conductor exposed portion 13 with the covering material 20. In the connecting step, the single wire 16 is connected to the terminal 30 including the terminal connector 32 configured to be connected to a mating terminal. In accordance with the manufacturing method according to the present embodiment, it is possible to manufacture the electric wire 1 with the terminal described above.

The entire content of Japanese Patent Application No. 2022-166071, filed on Oct. 17, 2022, is incorporated herein.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electric wire with a terminal comprising:
an electric wire that includes a conductor including a plurality of element wires and an insulation sheath covering an outer periphery of the conductor, and that includes therein a conductor exposed portion in which the conductor is exposed from the insulation sheath, and a conductor covered portion in which the conductor is covered with the insulation sheath, the conductor exposed portion including a single wire, the single wire being disposed at an end of the conductor, and the single wire being continuously and integrally connected to the plurality of element wires;
a covering material that spans a portion of the single wire and a portion of the insulation sheath to cover an entire surface of a bundle of the plurality of element wires of the conductor exposed portion; and
a terminal that includes a conductor connector connected to the single wire and a terminal connector configured to be connected to a mating terminal, wherein
the conductor connector is disposed at one end of the terminal, and the terminal connector is disposed at the other end of the terminal.

2. The electric wire with the terminal according to claim 1, wherein
an adhesive is disposed on an inner peripheral surface of the covering material.

3. A method of manufacturing an electric wire with a terminal comprising:
a step of covering an entire surface of a bundle of a plurality of element wires of a conductor exposed portion with a covering material by the covering material spanning a portion of a single wire and a portion of an insulation sheath, in an electric wire that includes a conductor including the plurality of element wires and the insulation sheath covering an outer periphery of the conductor, and that includes therein the conductor exposed portion in which the conductor is exposed from the insulation sheath, and a conductor covered portion in which the conductor is covered with the insulation sheath, the conductor exposed portion including the single wire, the single wire being disposed at an end of the conductor, and the single wire being continuously and integrally connected to the plurality of element wires; and
a step of connecting the single wire to a conductor connector of a terminal including the conductor connector and a terminal connector configured to be connected to a mating terminal, wherein
the conductor connector is disposed at one end of the terminal, and the terminal connector is disposed at the other end of the terminal.

4. The method of manufacturing the electric wire with the terminal according to claim 3, wherein
the single wire is formed by welding the plurality of element wires by ultrasonic welding.
